(19) United States
(12) Patent Application Publication
(10) Pub. No.: US 2024/0069267 A1
(43) Pub. Date: Feb. 29, 2024

(54) Optical Waveguide Assembly

(71) Applicant: SUNNY OMNILIGHT TECHNOLOGY(SHANGHAI) CO., LTD., Shanghai (CN)

(72) Inventors: Yifeng GAO, Shanghai (CN); Zhengkun YIN, Shanghai (CN); Linghe XIONG, Shanghai (CN); Shenwu YANG, Shanghai (CN); Qingwen ZHANG, Shanghai (CN); Jie WANG, Shanghai (CN); Yuan CHEN, Shanghai (CN)

(21) Appl. No.: 18/127,658

(22) Filed: Mar. 29, 2023

(30) Foreign Application Priority Data
Aug. 31, 2022 (CN) 202211056125.7

(51) Int. Cl. F21V 8/00

(52) U.S. Cl. CPC G02B 6/0043; G02B 6/0026

(57) ABSTRACT

The disclosure provides an optical waveguide assembly. The optical waveguide assembly includes: optical waveguide plates, where there are a plurality of optical waveguide plates, the plurality of optical waveguide plates are provided in an overlaid manner, each optical waveguide plate is provided with an in-coupling structure, a turning structure, an out-coupling structure and a diffraction inhibition layer, the turning structure and the out-coupling structure on the same optical waveguide plate are located on two side surfaces of the optical waveguide plate respectively, projections of the turning structure and the out-coupling structure on the optical waveguide plate are at least partially overlapped, and the diffraction inhibition layer is located between the out-coupling structure and the optical waveguide plate. Each turning structure includes a plurality of cellular elements. The disclosure solves a problem of non-uniform display efficiency of an optical waveguide assembly in the related art.

### CROSS-REFERENCE TO RELATED APPLICATION

This disclosure claims priority to Patent Application No. 202211056125.7, filed to China National Intellectual Property Administration on Aug. 31, 2022 and entitled “Optical Waveguide Assembly”, the disclosure of which is hereby incorporated by reference in its entirety.

### TECHNICAL FIELD

The disclosure relates to the technical field of diffraction optics, and particularly relates to an optical waveguide assembly.

### BACKGROUND

At present, display devices of virtual reality (VR), augmented reality (AR), mixed reality (MR), etc. have been widely used in the field of optical imaging. An optical waveguide assembly is the key to the AR, and is also a requisite for a main AR display solution. However, an existing optical waveguide assembly has some inherent defects. For example, its optical efficiency is low; and light of different field angles take different paths when they propagate in a waveguide, resulting in different utilization rates of the light, non-uniform output efficiency, and a large difference in display efficiency of a final image in eyes of users at various positions. Therefore, it is a direction of current research to improve a utilization rate of optical energy and uniformity of output light of a waveguide.

That is, an optical waveguide assembly in the related art has non-uniformity display problem.

### SUMMARY

A main objective of the disclosure is to provide an optical waveguide assembly, so as to solve a problem of non-uniform display efficiency of an optical waveguide assembly in the related art.

To achieve the objective, an embodiment of the disclosure provides an optical waveguide assembly. The optical waveguide assembly includes: optical waveguide plates, where there are a plurality of optical waveguide plates. The plurality of optical waveguide plates are provided in an overlaid manner, each optical waveguide plate of the plurality of optical waveguide plates is provided with an in-coupling structure, a turning structure, an out-coupling structure and a diffraction inhibition layer, the turning structure and the out-coupling structure on the same optical waveguide plate are located on two side surfaces of the optical waveguide plate respectively, projections of the turning structure and the out-coupling structure on the optical waveguide plate are at least partially overlapped, and the diffraction inhibition layer is located between the out-coupling structure and the optical waveguide plate. Each turning structure includes a plurality of cellular elements, and the plurality of cellular elements are provided in a rectangular array.

In an embodiment mode, there are at least two optical waveguide plates, and the in-coupling structure and the turning structure on the same optical waveguide plate are provided on the same side surface at a distance.

In an embodiment mode, there are one or more in-coupling structures on the same optical waveguide plate, and when there are a plurality of in-coupling structures, the plurality of in-coupling structures are provided at a distance; and/or projections of the plurality of in-coupling structures on adjacent optical waveguide plates of the plurality of optical waveguide plates are overlapped or staggered.

In an embodiment mode, the optical waveguide assembly further includes an optical engine, there are one or more optical engines, and the optical engine is configured to emit light to the in-coupling structure.

In an embodiment mode, when there is one optical engine, the optical engine is a multi-color optical engine, and when the multi-color optical engine emits light of at least three different wavebands, projections of the in-coupling structures on two adjacent optical waveguide plates of the plurality of optical waveguide plates on one of the optical waveguide plates are overlapped; and/or when there is a plurality of optical engines, the plurality of optical engines emit light of different wavebands, projections of the in-coupling structures on two adjacent optical waveguide plates of the plurality of optical waveguide plates on one of the optical waveguide plates are staggered, and the plurality of optical engines correspond one-to-one to the plurality of in-coupling structures on different optical waveguide plates.

In an embodiment mode, the cellular elements are rectangular, each rectangular cellular element of the cellular elements is divided into a plurality of grids, the plurality of grids are sequentially arranged in at least two directions, each grid of the plurality of grids is provided with a grating, and the gratings of the plurality of grids of the same cellular element are the same or different.

In an embodiment mode, a refractive index of the diffraction inhibition layer is smaller than a refractive index of the optical waveguide plate on which the diffraction inhibition layer is located.

In an embodiment mode, the diffraction inhibition layer is connected to the optical waveguide plate by means of optical adhesive or deposited on the optical waveguide plate through a coating process.

In an embodiment mode, a projection of the out-coupling structure of the same optical waveguide plate falls within a projection range of the diffraction inhibition layer on the same optical waveguide plate; and/or a projection of the diffraction inhibition layer of the same optical waveguide plate completely covers the optical waveguide plate.

In an embodiment mode, there is one diffraction inhibition layer on the same optical waveguide plate.

In an embodiment mode, each diffraction inhibition layer has a fixed refractive index or a refractive index that varies in a thickness direction of the diffraction inhibition layer.

In an embodiment mode, when the diffraction inhibition layer has a fixed refractive index, the diffraction inhibition layer has a refractive index greater than or equal to 1.65 and smaller than or equal to 2.65; and/or when the diffraction inhibition layer has a refractive index that varies in the thickness direction of the diffraction inhibition layer, the diffraction inhibition layer has a refractive index greater than or equal to 1.7 and smaller than or equal to 2.0; and/or when the diffraction inhibition layer has a refractive index that varies in the thickness direction of the diffraction inhibition layer, the diffraction inhibition layer has a refractive index that gradually decreases in a direction away from the optical waveguide plate on which the diffraction inhibition layer is located.

In an embodiment mode, the diffraction inhibition layer has a thickness greater than or equal to 100 nm and smaller than or equal to 1 mm; and/or the optical waveguide plate has a thickness greater than or equal to 400 μm and smaller than or equal to 1 mm; and/or the optical waveguide plate has a refractive index greater than or equal to 1.65 and smaller than or equal to 2.65.

In an embodiment mode, the in-coupling structures are one-dimensional gratings, and there are one or more layers of in-coupling structures, each layer having a height greater than or equal to 50 nm and smaller than or equal to 1000 nm; and/or the in-coupling structure has a duty cycle greater than or equal to 30% and smaller than or equal to 80%, and the in-coupling structure has a period greater than or equal to 300 nm and smaller than or equal to 600 nm.

In an embodiment mode, the turning structures are two-dimensional gratings, and there are one or more layers of turning structures, each layer having a height greater than or equal to 30 nm and smaller than or equal to 300 nm; and/or the turning structure has a duty cycle greater than or equal to 20% and smaller than or equal to 80%, and the turning structure has a period greater than or equal to 150 nm and smaller than or equal to 600 nm.

In an embodiment mode, the out-coupling structures are one-dimensional gratings, and there are one or more layers of out-coupling structures, each layer having a height greater than or equal to 30 nm and smaller than or equal to 500 nm; and/or the out-coupling structure has a duty cycle greater than or equal to 20% and smaller than or equal to 80%, and the out-coupling structure has a period greater than or equal to 200 nm and smaller than or equal to 600 nm.

According to the technical solution of the disclosure, the optical waveguide assembly includes: the optical waveguide plates, where there are the plurality of optical waveguide plates, the plurality of optical waveguide plates are provided in an overlaid manner, each optical waveguide plate is provided with the in-coupling structure, the turning structure, the out-coupling structure and the diffraction inhibition layer, the turning structure and the out-coupling structure on the same optical waveguide plate are located on the two side surfaces of the optical waveguide plate respectively, the projections of the turning structure and the out-coupling structure on the optical waveguide plate are at least partially overlapped, and the diffraction inhibition layer is located between the out-coupling structure and the optical waveguide plate. Each turning structure includes the plurality of cellular elements, and the plurality of cellular elements are provided in a rectangular array.

With the plurality of overlaid optical waveguide plates provided, light of different wavebands emitted from an external optical engine is transmitted in different optical waveguide plates, propagation paths of the light of different wavebands are planned, propagation stability is ensured, and the light of different wavebands corresponds to different colors, such that the optical waveguide assembly of the disclosure may implement propagation and display of color images. The optical waveguide plates provide positions for the in-coupling structures, the turning structures, the out-coupling structures and the diffraction inhibition layers, such that use reliability of the in-coupling structures, the turning structures, the out-coupling structures and the diffraction inhibition layers is improved. The in-coupling structures are configured to couple the light emitted from the external optical engine into the optical waveguide plates, and diffract the coupled-in light towards the turning structures at different angles. The turning structures are configured to receive light diffractted from the in-coupling structures, to change directions of the light in the optical waveguide plates, to conduct propagation in a pupil-expansion manner, and further conduct propagation to the out-coupling structures. The out-coupling structures are configured to receive light transmitted from the turning structures and couple the light out of the optical waveguide plates, so as to uniformly and efficiently couple the light of the external optical engine out to human eyes for imaging display. Projections of the turning structures and the out-coupling structures on the optical waveguide plates are at least partially overlapped. In this way, actual occupied sizes of the turning structures and the out-coupling structures on the optical waveguide plates are reduced, such that sizes of the optical waveguide plates are reduced, and miniaturization of the optical waveguide assembly is achieved; and meanwhile, propagation paths from the turning structures to the out-coupling structures are shortened, loss of optical energy in a propagation process is reduced, and propagation efficiency of a system is ensured.

In addition, each turning structure includes the plurality of cellular elements, and the plurality of cellular elements are provided in a rectangular array. Each turning structure is provided to have a form of the rectangular array of the plurality of cellular elements, such that it is ensured that the turning structure receives most of light transmitted from the in-coupling structure and transmits most of the light to the out-coupling structure in a pupil-expansion manner in a specific direction, which ensures propagation efficiency advantageously. In an actual propagation process, part of light is directly affected by the out-coupling structures after passing through the in-coupling structures, the energy of the part of light is lost, and finally, efficiency of coupling the light out to some areas in human eyes is lower than that of coupling the light out to other areas, resulting in low output efficiency and non-uniform display. The diffraction inhibition layers are provided between the out-coupling structures and the optical waveguide plates, such that the light passes through the diffraction inhibition layers and then reaches the out-coupling structures, the diffraction inhibition layers may suppress an early diffraction phenomenon caused by the out-coupling structures, leaking of the optical energy is prevented, output efficiency of the optical waveguide assembly is improved, and uniformity of output light is improved on the premise of ensuring field of view (FOV). That is, the diffraction inhibition layers reduce optical energy loss when the light reaches the out-coupling structures, and retain the optical energy in the optical waveguide plates, such that overall display efficiency of the optical waveguide assembly is improved, and uniformity of the output light is also improved.

### BRIEF DESCRIPTION OF THE DRAWINGS

The drawings of the description, which form a part of the disclosure, are used to provide further understanding of the disclosure, and illustrative embodiments of the disclosure and the description thereof are used to explain the disclosure, which are not intended to unduly limit the disclosure. In the drawings:

FIG. 1 shows a K-domain distribution diagram of an optical waveguide assembly in the related art;

FIG. 2 shows a schematic structural diagram of an optical waveguide assembly in the related art from a view;

FIG. 3 shows a schematic structural diagram of an optical waveguide assembly in the related art in FIG. 2 from another view;

FIG. 4 shows a schematic structural diagram of an optical waveguide assembly of Embodiment 1 of the disclosure;

FIG. 5 shows a schematic diagram of a turning structure in FIG. 4;

FIG. 6 is a schematic structural diagram of an optical waveguide assembly of Embodiment 2 of the disclosure;

FIG. 7 shows a diffraction efficiency diagram of an optical waveguide assembly without a diffraction inhibition layer in the related art; and

FIG. 8 shows a diffraction efficiency diagram of an optical waveguide assembly of an optional embodiment of the disclosure.

The above drawings include the following reference numerals:
10, optical waveguide plate; 21, in-coupling grating; 22, turning grating; 23, out-coupling grating; 30, in-coupling structure; 40, turning structure; 41, cellular element; 411, grid; 50, out-coupling structure; and 60, diffraction inhibition layer.

### DETAILED DESCRIPTION OF THE EMBODIMENTS

It should be noted that embodiments in the disclosure and features in the embodiments can be combined with one another if there is no conflict. The disclosure is described in detail below with reference to the drawings and the embodiments.

It should be noted that all technical and scientific terms used in the disclosure have the same meanings as commonly understood by those of ordinary skill in the art to which the disclosure belongs unless otherwise indicated.

In the disclosure, unless otherwise stated, the orientation words such as “upper, lower, top and bottom” are usually used for directions shown in the drawings, or for parts themselves in vertical, perpendicular or gravity directions; and similarly, for convenience of understanding and description, “inside or outside” refers to inside or outside relative to an outline of each component itself, but the above orientation words are not used to limit the disclosure.

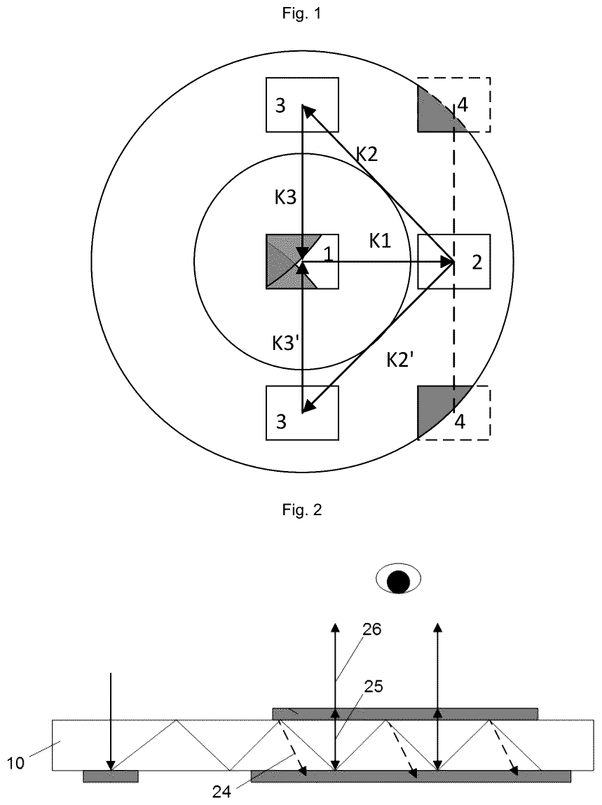

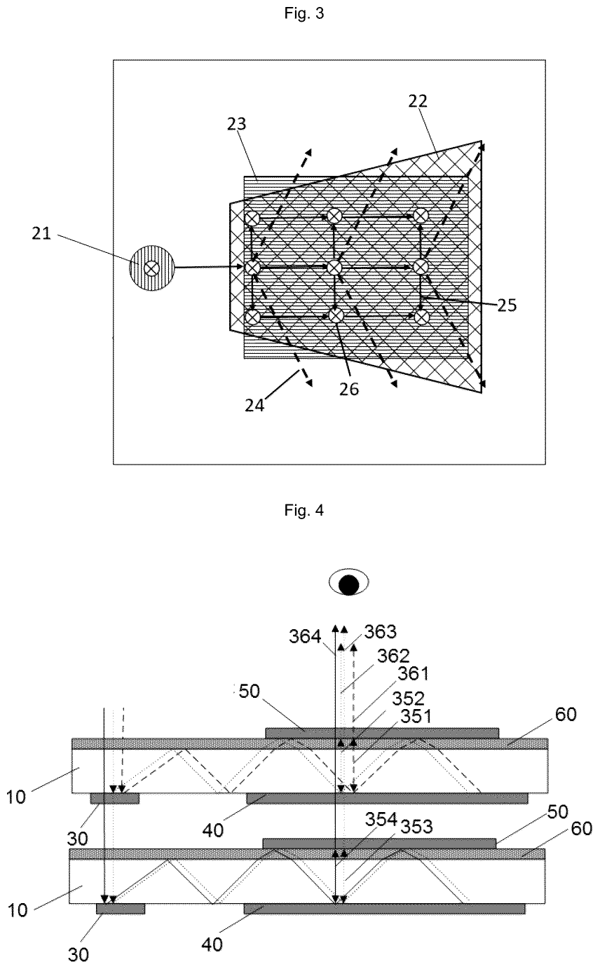

FIGS. 1-3 show an optical waveguide assembly in the related art. FIG. 1 shows a K-domain distribution diagram of an optical waveguide assembly in the related art. 1, 2, and 3 may represent three states. 1 represents a state when light enters an optical waveguide plate (or when the light is coupled out of the optical waveguide plate). 2 represents a state when the light is transmitted into the optical waveguide plate via an in-coupling grating 21. 3 represents a state after the light is transmitted via a turning grating 22 in a pupil-expansion manner. 4 represents a state after the light is directly affected by an out-coupling grating 23 after passing through the in-coupling grating 21. K1 is a grating vector of the in-coupling grating 21, and indicates a vector superposed when a wave vector passes through the in-coupling grating 21. K2 is a grating vector of the turning grating 22, and indicates a vector superposed when the wave vector passes through the turning grating 22. K3 is a grating vector of the out-coupling grating 23, and indicates a vector superposed when the wave vector passes through the out-coupling grating 23. K1, K2 and K3 form a closed loop. However, in an actual propagation process of the light, part of the light is directly affected by the out-coupling grating 23 (area 4) after passing through K1 of the in-coupling grating 21, resulting in partial optical energy loss. Finally, diffraction efficiency of coupling the light out to the area (area 4) in human eyes by the out-coupling grating 23 is lower than that of coupling the light out to other areas. FIG. 2 shows a schematic structural diagram of an optical waveguide assembly in the related art. As is seen from the figure, a lower surface of the optical waveguide plate is provided with the in-coupling grating 21 and the turning grating 22 at a distance, and an upper surface of the optical waveguide plate is provided with the out-coupling grating 23. 24 being optical energy loss, 25 being pupil-expansion light, and 26 being coupled-out light. FIG. 3 shows a schematic diagram of an optical waveguide assembly in FIG. 2, from another view.

To solve a problem of non-uniform display efficiency of an optical waveguide assembly in the related art, the disclosure provides an optical waveguide assembly.

As shown in FIGS. 4-8, the optical waveguide assembly includes optical waveguide plates 10, where there are a plurality of optical waveguide plates 10, the plurality of optical waveguide plates 10 are provided in an overlaid manner, each optical waveguide plate 10 is provided with an in-coupling structure 30, a turning structure 40, an out-coupling structure 50 and a diffraction inhibition layer 60, the turning structure 40 and the out-coupling structure 50 on the same optical waveguide plate 10 are located on two side surfaces of the optical waveguide plate 10 respectively, projections of the turning structure 40 and the out-coupling structure 50 on the optical waveguide plate 10 are at least partially overlapped, the in-coupling structure 30 is located at the same side with the turning structure 40 or the out-coupling structure 50, and the diffraction inhibition layer 60 is located between the out-coupling structure 50 and the optical waveguide plate 10. Each turning structure 40 includes a plurality of cellular elements 41, and the plurality of cellular elements 41 are provided in a rectangular array.

With the plurality of overlaid optical waveguide plates 10 provided, light of different wavebands emitted from an external optical engine is transmitted in different optical waveguide plates 10, propagation paths of the light of different wavebands are planned, propagation stability is ensured, and the light of different wavebands corresponds to different colors, such that the optical waveguide assembly of the disclosure may implement propagation and display of color images. The optical waveguide plates 10 provide positions for the in-coupling structures 30, the turning structures 40, the out-coupling structures 50 and the diffraction inhibition layers 60, such that use reliability of the in-coupling structures 30, the turning structures 40, the out-coupling structures 50 and the diffraction inhibition layers 60 is improved. The in-coupling structures 30 are configured to couple the light emitted from the external optical engine into the optical waveguide plates 10, and diffract and transmit the coupled-in light towards the turning structures 40 at different angles. The turning structures 40 are configured to receive light transmitted from the in-coupling structures 30, change propagation directions of the light in the optical waveguide plates 10, conduct propagation in a pupil-expansion manner, and further conduct propagation to the out-coupling structures 50. The out-coupling structures 50 are configured to receive light transmitted from the turning structures 40 and couple the light out of the optical waveguide plates 10, so as to uniformly and efficiently couple the light of the external optical engine out to human eyes for imaging display. Projections of the turning structures 40 and the out-coupling structures 50 on the optical waveguide plates 10 are at least partially overlapped. In this way, actual occupied sizes of the turning structures 40 and the out-coupling structures 50 on the optical waveguide plates 10 are reduced, such that sizes of the optical waveguide plates 10 are reduced, and miniaturization of the optical waveguide assembly is ensured; and meanwhile, propagation paths from the turning structures 40 to the out-coupling structures 50 are shortened, loss of optical energy in a propagation process is reduced, and propagation efficiency of a system is ensured.

In addition, each turning structure 40 includes the plurality of cellular elements 41, and the plurality of cellular elements 41 are provided in a rectangular array. Each turning structure 40 is provided to have a form of the rectangular array of the plurality of cellular elements 41, such that it is ensured that the turning structure 40 receives most of light transmitted from the in-coupling structure 30 and transmits most of the light to the out-coupling structure 50 in a pupil-expansion manner in a specific direction, which ensures propagation efficiency advantageously. In an actual propagation process, part of light is directly affected by the out-coupling structures 50 after passing through the in-coupling structures 30, the energy of the part of light is lost, and finally, efficiency of coupling the light out to some areas in human eyes is lower than that of coupling the light out to other areas, resulting in low output efficiency and non-uniform display. The diffraction inhibition layers 60 are provided between the out-coupling structures 50 and the optical waveguide plates 10, such that the light passes through the diffraction inhibition layers 60 and then reaches the out-coupling structures 50, the diffraction inhibition layers 60 may suppress an early diffraction phenomenon caused by the out-coupling structures 50, leaking of the optical energy is prevented, output efficiency of the optical waveguide assembly is improved, and uniformity of output light is improved on the premise of ensuring field of view (FOV). That is, the diffraction inhibition layers 60 reduce optical energy loss when the light reaches the out-coupling structures 50, and retain the optical energy in the optical waveguide plates 10, such that overall display efficiency of the optical waveguide assembly is improved, and uniformity of the output light is also improved.

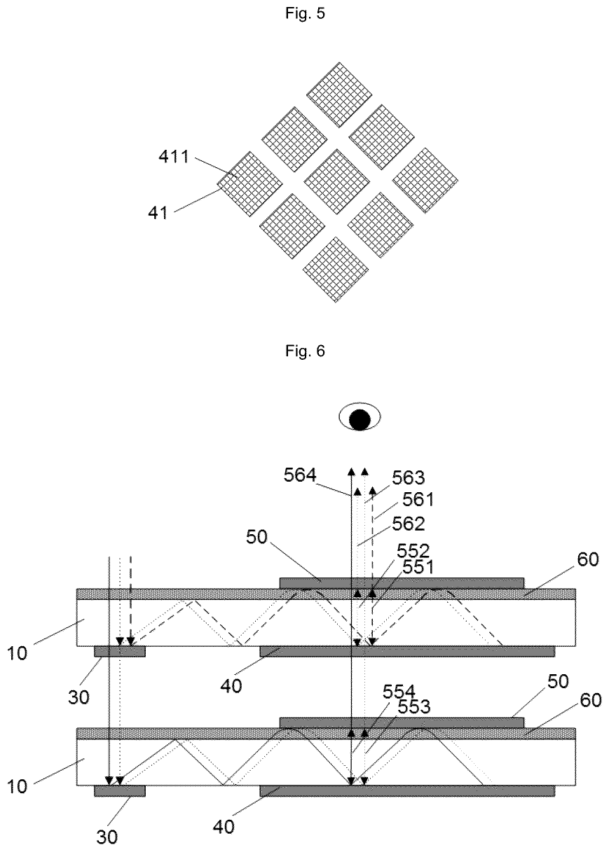

As shown in FIG. 5, the plurality of cellular elements 41 of each turning structure 40 are provided in a rectangular array, that is, it is understood that a shape formed by providing the plurality of cellular elements 41 in an array is rectangular, that is, a shape of the turning structure 40 is rectangular. Each turning structure 40 is provided in a rectangular array of the plurality of cellular elements 41, to match the diffraction inhibition layer 60, so as to better match the diffraction inhibition layer 60 to ensure normal use of the diffraction inhibition layer 60 and a use effect of the diffraction inhibition layer 60.

To sum up, an augmented reality (AR) head-mounted device or a vehicle-mounted head up display (HUD) has become a hot spot in current scientific research, and has gradually entered daily lives of people. As a mainstream AR design solution, an optical waveguide assembly receives widespread attention because of a small size, but the optical waveguide assembly also has inherent defects such as low system efficiency, poor angle uniformity and poor eye box uniformity, which seriously restrict application of the optical waveguide assembly in an AR device. The disclosure provides a diffractive waveguide, which may suppress the early diffraction phenomenon caused by the out-coupling structures 50, prevent leaking of the optical energy, improve optical efficiency of the optical waveguide assembly, and improve uniformity of output light is improved on the premise of ensuring FOV.

As shown in FIG. 4, in an optional embodiment, there are at least two optical waveguide plates 10, and each optical waveguide plate 10 is provided with an in-coupling structure 30, a turning structure 40, an out-coupling structure 50 and a diffraction inhibition layer 60. The in-coupling structure 30 and the turning structure 40 on the same optical waveguide plate 10 are provided on the same side surface at a distance. For example, as shown in FIG. 4, the in-coupling structure 30 and the turning structure 40 on each of the two optical waveguide plates 10 are both provided on the same side surface at a distance. With the optical waveguide plate 10 at an upper side as an example, the in-coupling structure 30 and the turning structure 40 are provided on a lower surface of the optical waveguide plate 10 at a distance, the surface on which the in-coupling structure 30 and the turning structure 40 are located is provided with no diffraction inhibition layer 60, the other side surface of the optical waveguide plate 10 is provided with the diffraction inhibition layer 60, one side surface of the diffraction inhibition layer 60 away from the optical waveguide plate 10 is provided with the out-coupling structure 50, and projections of the turning structure 40 and the out-coupling structure 50 on the optical waveguide plate 10 are overlapped, that is, the projections of the turning structure 40 and the out-coupling structure 50 on the optical waveguide plate 10 directly correspond to each other. Since the turning structure 40 and the out-coupling structure 50 are different in size and shape, when the turning structure 40 and the out-coupling structure 50 are provided on two side surfaces of the optical waveguide plate 10 in a direct correspondence manner, the projections of the turning structure 40 and the out-coupling structure 50 on the optical waveguide plate 10 are not completely overlapped but mostly overlapped, but the projections of the turning structure 40 and the out-coupling structure 50 on the optical waveguide plate 10 are not staggered or spaced.

Specifically, there are one or more in-coupling structures 30 on the same optical waveguide plate 10. In an embodiment of the disclosure, there is one in-coupling structure 30 on the same optical waveguide plate 10, and projections of a plurality of in-coupling structures 30 on different optical waveguide plates 10 on adjacent optical waveguide plates 10 are overlapped or staggered. However, in an embodiment not shown in the disclosure, there is the plurality of in-coupling structures 30 on the same optical waveguide plate 10, the plurality of in-coupling structures 30 are provided at a distance, and the plurality of in-coupling structures 30 are capable of in-coupling light of different colors.

Specifically, the optical waveguide assembly further includes an optical engine, there are one or more optical engines, and the optical engine is configured to emit light to the in-coupling structure 30. When there is one optical engine, the optical engine is a multi-color optical engine, and when the multi-color optical engine is capable of transmitting light of at least three different wavebands, such as blue light, green light and red light, projections of the input coupling structures 30 on two adjacent optical waveguide plates 10 of the plurality of optical waveguide plates 10 on one of the optical waveguide plates 10 are overlapped. That is, the in-coupling structures 30 on the plurality of optical waveguide plates 10 are the same in position and size. From a top view of the optical waveguide assembly, only one in-coupling structure 30 is seen. In this case, wavelengths of light coupled-in by the in-coupling structures 30 on different optical waveguide plates 10 is the same or different. With a specific embodiment in FIG. 4 as an example, the multi-color optical engine emits blue light, green light and red light. An in-coupling structure 30 on an optical waveguide plate 10 at an upper side is capable of in-coupling blue light and green light, and an in-coupling structure 30 on an optical waveguide plate 10 at a lower side is capable of in-coupling green light and red light. Wavebands of light coupled-in by different in-coupling structures 30 are planned to implement color display.

In an embodiment not shown in the disclosure, when there are a plurality of optical engines, the plurality of optical engines emit light of different wavebands, and projections of the in-coupling structures 30 on two adjacent optical waveguide plates 10 of the plurality of optical waveguide plates 10 on one of the optical waveguide plates 10 are staggered. That is, the plurality of coupling structures 30 on the plurality of optical waveguide plates 10 are not overlapped. From a top view of the optical waveguide assembly, the plurality of in-coupling structures 30 that are staggered is seen. In this way, the plurality of optical engines may correspond one-to-one to the plurality of in-coupling structures 30 on different optical waveguide plates 10, such that different in-coupling structures 30 may in-couple light of different wavebands, to ensure a final color display effect. The plurality of in-coupling structures 30 are provided to cooperate with the optical engines, so as to implement color display.

As shown in FIG. 5, the cellular elements 41 are rectangular, the plurality of rectangular cellular elements 41 are arranged at a distance in two directions perpendicular to each other, each rectangular cellular element 41 is divided into a plurality of grids 411, the plurality of grids 411 are sequentially arranged in at least two directions, each grid 411 is provided with a grating, and the gratings of the plurality of grids 411 of the same cellular element 41 are the same or different. That is, the grating in each grid 411 is random. In this way, a pupil expansion effect of the turning structures 40 on light is ensured, diffraction of the light to positions of the out-coupling structures 50, and a pupil-expansion effect of the turning structures 40 is enhanced. In a specific embodiment shown in FIG. 5, there is three rows of cellular elements 41, the three rows of cellular elements 41 are parallel to each other, and each row is provided with three rectangular cellular elements 41 provided at a distance.

Specifically, the diffraction inhibition layers 60 have a smaller refractive index than the optical waveguide plates 10 on which the diffraction inhibition layers are located. A low refractive index of the diffraction inhibition layers 60 may suppress a diffraction order of the out-coupling structures 50 for causing energy leakage in advance, without affecting a diffraction order required for normal out-coupling, such that energy loss caused by light at the out-coupling structures 50 is reduced.

Specifically, the diffraction inhibition layers 60 are bonded to the optical waveguide plates 10 by means of optical adhesive or deposited on the optical waveguide plates 10 through a coating process. A mature bonding process may ensure structural strength of the diffraction inhibition layers 60 to be high enough. A mature coating and deposition process may ensure high processing accuracy. The process is selected according to an actual case.

As shown in FIG. 4, a projection of the out-coupling structure 50 of the same optical waveguide plate 10 on the optical waveguide plate 10 falls within a projection range of the diffraction inhibition layer 60 on the optical waveguide plate 10. That is, the diffraction inhibition layer 60 has a greater area than the out-coupling structure 50. In a specific embodiment in the figure, a projection of the diffraction inhibition layer 60 on the same optical waveguide plate 10 on the optical waveguide plate 10 completely covers the optical waveguide plate 10. That is, the diffraction inhibition layer 60 has the same area as the optical waveguide plate 10 on which the diffraction inhibition layer is located. Sizes of the diffraction inhibition layers 60 are rationally planned, and it is ensured that the diffraction inhibition layers 60 receive light transmitted from the turning structures 40 before the out-coupling structures 50, such that an early diffraction phenomenon is suppressed, light loss is avoided, and system efficiency is ensured.

Certainly, in other optional embodiments, the diffraction inhibition layer 60 on the same optical waveguide plate 10 may only be provided between the out-coupling structure 50 and the optical waveguide plate 10, that is, the diffraction inhibition layer 60 has the same area as the out-coupling structure 50.

Specifically, the diffraction inhibition layer 60 has a thickness greater than or equal to 100 nm and smaller than or equal to 1 mm. An effect of the diffraction inhibition layer 60 mainly acts on an interface between the diffraction inhibition layer 60 and the out-coupling structure 50, so as to provide an emitting environment having a low refractive index for the out-coupling structure 50, to suppress a corresponding diffraction order. Therefore, the thickness of the diffraction inhibition layer 60 is set in a broad thickness range greater than or equal to 100 nm and smaller than or equal to 1 mm, such that a use effect of the diffraction inhibition layer 60 is ensured.

Specifically, there is one diffraction inhibition layer 60 on the same optical waveguide plate 10. When there is one diffraction inhibition layer 60 on the same optical waveguide plate 10, the diffraction inhibition layer 60 is a diffraction inhibition layer 60 having a fixed refractive index or a refractive index that varies in a thickness direction of the diffraction inhibition layer. The diffraction inhibition layer has a fixed refractive index, that is, a material of the diffraction inhibition layer 60 has a fixed refractive index. In this case, the diffraction inhibition layer has a refractive index greater than or equal to 1.65 and smaller than or equal to 2.65. As long as the diffraction inhibition layer 60 has a lower refractive index than the optical waveguide plate 10 on which the diffraction inhibition layer is located, a function of reducing optical energy loss during out-coupling is achieved. The diffraction inhibition layer has a refractive index that varies in the thickness direction of the diffraction inhibition layer, that is, the diffraction inhibition layer has a refractive index that is not fixed and gradually increases or decreases in the thickness direction of the diffraction inhibition layer, that is, a material of the diffraction inhibition layer 60 has a refractive index that gradually varies. In this case, the diffraction inhibition layer has a refractive index greater than or equal to 1.7 and smaller than or equal to 2.0. The refractive index of the diffraction inhibition layer 60 is set to gradually vary, so as to conducive to elimination of Fresnel reflection. For example, in an optional embodiment of the disclosure, when the diffraction inhibition layer has a refractive index that varies in the thickness direction of the diffraction inhibition layer, the diffraction inhibition layer has a refractive index that gradually decreases in a direction away from the optical waveguide plate, and a connecting part between the diffraction inhibition layer and the optical waveguide plate has the same refractive index as the optical waveguide plate, such that Fresnel reflection caused by a refractive index difference at a critical interface is eliminated.

In addition, when there is one diffraction inhibition layer 60 on the same optical waveguide plate 10, the optical waveguide assembly further includes an anti-reflection film, and the anti-reflection film is provided between the diffraction inhibition layer 60 and the optical waveguide plate 10. The anti-reflection film is provided to reduce interface reflection caused by refractive index mismatch between the diffraction inhibition layer 60 and the optical waveguide plate 10.

Specifically, one optical waveguide plate 10 has a thickness greater than or equal to 400 μm and smaller than or equal to 1 mm. By rationally restricting a thickness of the optical waveguide plate 10, an influence of a too small thickness on structural strength is avoided, and an increase in an overall weight of the optical waveguide assembly caused by a too great thickness is avoided. The thickness of the optical waveguide plate 10 is restricted in a range of 400 μm to 1 mm, such that working stability of the optical waveguide plate 10 is ensured, and a light weight of the optical waveguide assembly is ensured. The optical waveguide plate 10 has a refractive index greater than or equal to 1.65 and smaller than or equal to 2.65. By setting the refractive index of the optical waveguide plate 10 in a broad range, an optical waveguide plate 10 having a high refractive index may ensure a larger field of view. The higher the refractive index is, the greater the field of view that is accommodated in the optical waveguide plate 10 is.

Specifically, the in-coupling structures 30 are one-dimensional gratings, and there are one or more layers of in-coupling structures 30, each layer having a height greater than or equal to 50 nm and smaller than or equal to 1000 nm. The in-coupling structures 30 each have a duty cycle greater than or equal to 30% and smaller than or equal to 80%, and the in-coupling structures 30 each have a period greater than or equal to 300 nm and smaller than or equal to 600 nm. Specific parameters of the in-coupling structures 30 are restricted in a rational range, it is ensured that the in-coupling structures 30 diffract incident light into different angles and make the light enter the optical waveguide plate 10 in a specific order for propagation, and then the light emitted from the external optical engine is uniformly guided into the optical waveguide plate 10 with maximum power.

Specifically, the turning structures 40 are two-dimensional gratings, the cellular elements 41 of the turning structures 40 are preferably square, and there are one or more layers of turning structures 40, each layer having a height greater than or equal to 30 nm and smaller than or equal to 300 nm. The turning structures 40 each have a duty cycle greater than or equal to 20% and smaller than or equal to 80%, and the turning structures 40 each have a period greater than or equal to 150 nm and smaller than or equal to 600 nm. Parameters of the turning structures 40 are restricted in a rational range, such that it is ensured that the turning structures 40 receive light from the in-coupling structures 30, a propagation direction of the light in the optical waveguide plates 10 is changed, and meanwhile, propagation is conducted in a pupil-expansion manner.

Specifically, the out-coupling structures 50 are one-dimensional gratings, and there are one or more layers of out-coupling structures 50, each layer having a height greater than or equal to 30 nm and smaller than or equal to 500 nm. The out-coupling structures 50 each have a duty cycle greater than or equal to 20% and smaller than or equal to 80%, and the out-coupling structures 50 each have a period greater than or equal to 200 nm and smaller than or equal to 600 nm. Parameters of the out-coupling structures 50 are restricted in a rational range, such that it is ensured that the out-coupling structures 50 receive light transmitted from the turning structures 40, and couple the light out, and then information of an optical engine is uniformly and efficiently coupled out to human eyes.

The optical waveguide assembly of the disclosure will be described with reference to the following specific embodiments and drawings.

### Embodiment 1

FIGS. 4 and 5 show a schematic diagram of an optical waveguide assembly of Embodiment 1.

As shown in FIG. 4, the optical waveguide assembly includes two optical waveguide plates 10, and each optical waveguide plate 10 is provided with an in-coupling structure 30, a turning structure 40, an out-coupling structure 50 and a diffraction inhibition layer 60. With the optical waveguide plate 10 at an upper side as an example, a lower surface of the optical waveguide plate 10 is provided with the in-coupling structure 30 and the turning structure 40 at a distance, an upper surface of the optical waveguide plate 10 is completely covered with a diffraction inhibition layer 60, and an upper surface of the diffraction inhibition layer 60 is provided with the out-coupling structure 50, and projections of the turning structure 40 and the out-coupling structure 50 on the optical waveguide plate 10 are mostly overlapped.

In the embodiment, there is one diffraction inhibition layer 60 on each of the two optical waveguide plates 10, and a material of the diffraction inhibition layers 60 has a fixed refractive index.

As shown in FIG. 4, the two optical waveguide plates 10 are divided into the optical waveguide plate 10 at the upper side and the optical waveguide plate 10 at a lower side. As shown by the optical waveguide plate 10 at the upper side, 351 is pupil-expansion light of a first wavelength that passes through the optical waveguide plate 10 at the upper side, 352 is pupil-expansion light of a second wavelength that passes through the optical waveguide plate 10 at the upper side, 361 is light of a first wavelength that is coupled out by the optical waveguide plate 10 at the upper side, and 362 is light of a second wavelength that is coupled out by the optical waveguide plate 10 at the upper side. As shown by the optical waveguide plate 10 at the lower side, 353 is pupil-expansion light of a second wavelength that passes through the optical waveguide plate 10 at the lower side, 354 is pupil-expansion light of a third wavelength that passes through the optical waveguide plate 10 at the lower side, 363 is light of a second wavelength that coupled out by the optical waveguide plate 10 at the lower side, and 364 is light of a third wavelength that is coupled out by the optical waveguide plate 10 at the lower side. The light of the first wavelength is blue light, the light of the second wavelength is green light, and the light of the third wavelength is red light.

As shown in FIG. 4, the in-coupling structure 30 of the optical waveguide plate 10 at the upper side has a height in a range greater than or equal to 150 nm and smaller than or equal to 250 nm, the number of steps of 1-4, and a period of 350 nm. The turning structure 40 of the optical waveguide plate 10 at the upper side has a height of in a range greater than or equal to 30 nm and smaller than or equal to 80 nm, a duty cycle in a range greater than or equal to 40% and smaller than or equal to 60%, and a period of 247.49 nm*247.49 nm. The out-coupling structure 50 of the optical waveguide plate 10 at the upper side has a height in a range greater than or equal to 120 nm and smaller than or equal to 180 nm, a duty cycle in a range greater than or equal to 40% and smaller than or equal to 60%, and a period of 380 nm. The optical waveguide plate 10 at the upper side has a refractive index of 2.0, and the diffraction inhibition layer 60 on the optical waveguide plate 10 at the upper side has a refractive index of 1.7.

As shown in FIG. 4, the in-coupling structure 30 of the optical waveguide plate 10 at the lower side has a height in a range greater than or equal to 150 nm and smaller than or equal to 250 nm, the number of steps of 1-4, and a period of 450 nm. The turning structure 40 of the optical waveguide plate 10 at the lower side has a height in a range greater than or equal to 30 nm and smaller than or equal to 80 nm, a duty cycle in a range greater than or equal to 40% and smaller than or equal to 60%, and a period of 318.20 nm*318.20 nm. The out-coupling structure 50 of the optical waveguide plate 10 at the lower side has a height in a range greater than or equal to 120 nm and smaller than or equal to 180 nm, a duty cycle in a range greater than or equal to 40% and smaller than or equal to 60%, and a period of 450 nm. The optical waveguide plate 10 at the lower side has a refractive index of 2.0, and the diffraction inhibition layer 60 on the optical waveguide plate 10 at the lower side has a refractive index of 1.7.

### Embodiment 2

FIG. 6 shows a schematic diagram of an optical waveguide assembly of Embodiment 2.

Compared with Embodiment 1, in the embodiment, there is one diffraction inhibition layer 60 on each of two optical waveguide plates 10, and a material of the diffraction inhibition layers 60 has a refractive index that gradually varies in a thickness direction of the diffraction inhibition layers.

As shown in FIG. 4, the two optical waveguide plates 10 are divided into the optical waveguide plate 10 at the upper side and the optical waveguide plate 10 at a lower side. As shown by the optical waveguide plate 10 at the upper side, 551 is pupil-expansion light of a first wavelength that passes through the optical waveguide plate 10 at the upper side, 552 is pupil-expansion light of a second wavelength that passes through the optical waveguide plate 10 at the upper side, 561 is light of a first wavelength that coupled out by the optical waveguide plate 10 at the upper side, and 562 is light of a second wavelength that is coupled out by the optical waveguide plate 10 at the upper side. As shown by the optical waveguide plate 10 at the lower side, 553 is pupil-expansion light of a second wavelength that passes through the optical waveguide plate 10 at the lower side, 554 is pupil-expansion light of a third wavelength that passes through the optical waveguide plate 10 at the lower side, 563 is light of a second wavelength that coupled out by the optical waveguide plate 10 at the lower side, and 564 is light of a third wavelength that is coupled out by the optical waveguide plate 10 at the lower side. The light of the first wavelength is blue light, the light of the second wavelength is green light, and the light of the third wavelength is red light.

As shown in FIG. 4, the in-coupling structure 30 of the optical waveguide plate 10 at the upper side has a height in a range greater than or equal to 150 nm and smaller than or equal to 250 nm, the number of steps of 1-4, and a period of 350 nm. The turning structure 40 of the optical waveguide plate 10 at the upper side has a height in a range greater than or equal to 30 nm and smaller than or equal to 80 nm, a duty cycle in a range greater than or equal to 40% and smaller than or equal to 60%, and a period of 247.49 nm*247.49 nm. The out-coupling structure 50 of the optical waveguide plate 10 at the upper side has a height in a range greater than or equal to 120 nm and smaller than or equal to 180 nm, a duty cycle in a range greater than or equal to 40% and smaller than or equal to 60%, and a period of 350 nm. The optical waveguide plate 10 at the upper side has a refractive index of 2.0, and the diffraction inhibition layer 60 on the optical waveguide plate 10 at the upper side has a refractive index of 1.7-2.0.

As shown in FIG. 4, the in-coupling structure 30 of the optical waveguide plate 10 at the lower side has a height in a range greater than or equal to 150 nm and smaller than or equal to 250 nm, the number of steps of 1-4, and a period of 450 nm. The turning structure 40 of the optical waveguide plate 10 at the lower side has a height in a range greater than or equal to 30 nm and smaller than or equal to 80 nm, a duty cycle in a range greater than or equal to 40% and smaller than or equal to 60%, and a period of 318.20 nm*318.20 nm. The out-coupling structure 50 of the optical waveguide plate 10 at the lower side has a height in a range greater than or equal to 120 nm and smaller than or equal to 180 nm, a duty cycle in a range greater than or equal to 40% and smaller than or equal to 60%, and a period of 450 nm. The optical waveguide plate 10 at the lower side has a refractive index of 2.0, and the diffraction inhibition layer 60 on the optical waveguide plate 10 at the lower side has a refractive index of 1.7-2.0.

The diffraction inhibition layer 60 on the optical waveguide plate 10 at the upper side has the same refractive index change law as the diffraction inhibition layer 60 on the optical waveguide plate 10 at the lower side. With the diffraction inhibition layer 60 on the optical waveguide plate 10 of an upper layer as an example, the diffraction inhibition layer 60 has a refractive index that gradually decreases from the optical waveguide plate 10 on which the diffraction inhibition layer is located to the out-coupling structure 50. Specifically, the diffraction inhibition layer 60 may include seven refractive indexes, and the seven refractive indexes are 2.0, 1.95, 1.9, 1.85, 1.8, 1.75 and 1.7 in a direction perpendicular to the optical waveguide plate 10, from the optical waveguide plate 10 on which the diffraction inhibition layer is located to the out-coupling structure 50. The optical waveguide plate 10 has a refractive index of 2.0. The example is for illustration only. Actually, change of the refractive index of the diffraction inhibition layer 60 is set according to an actual case.

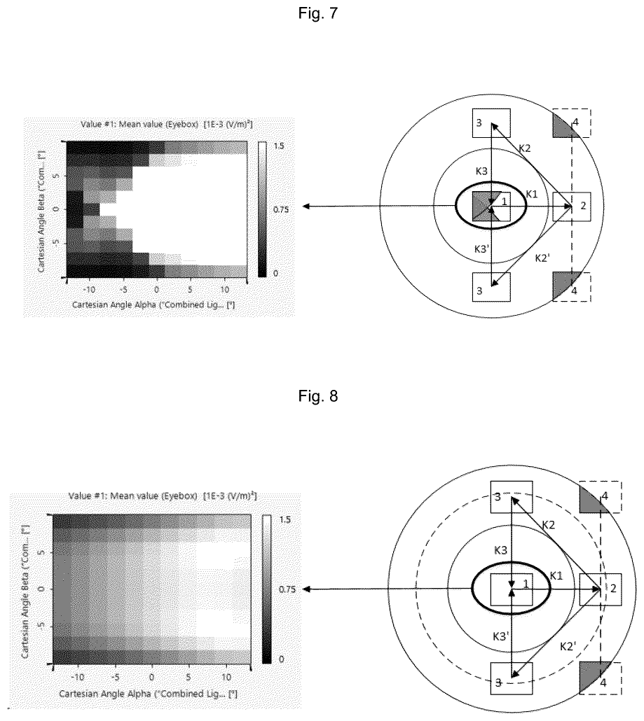

FIG. 7 shows a diffraction efficiency diagram of an optical waveguide assembly without a diffraction inhibition layer 60 in the related art. FIG. 8 shows a diffraction efficiency diagram of an optical waveguide assembly of the disclosure. The higher a gray value is, the lower efficiency is, and the lower the gray value is, the higher the efficiency is. In the disclosure, the diffraction inhibition layers 60 are provided, such that efficiency of some areas is obviously improved as a whole, and uniformity is also improved.

Apparently, the embodiments described are merely some embodiments rather than all embodiments of the disclosure. Based on the embodiments of the disclosure, all other embodiments obtained by those of ordinary skill in the art without making inventive efforts should all fall within the scope of protection of the disclosure.

It should be noted that the terms used herein are merely for describing the detailed description of the embodiments and are not intended to limit illustrative embodiments according to the disclosure. As used herein, singular is also intended to include plural unless the context clearly points out singular or plural. In addition, it should be understood that terms “include” and/or “comprise”, when used in the description, indicate the presence of features, steps, operations, devices, assemblies, and/or combinations of the foregoing.

It should be noted that the terms “first”, “second”, etc., in the description and claims of the disclosure and in the drawings, are used to distinguish between similar objects and not necessarily to describe a particular order or sequential order. It should be understood that data used in this way is interchanged where appropriate, such that the embodiments of the disclosure described herein is implemented in other sequences than those illustrated or described herein.

The above descriptions are merely preferred embodiments of the disclosure and are not intended to limit the disclosure, which is modified and changed, for those skilled in the art. Any modification, equivalent substitution, improvement, etc. within the spirit and principles of the disclosure shall fall within the protection scope of the disclosure.

What is claimed is:

1. An optical waveguide assembly, comprising:
optical waveguide plates, wherein there are a plurality of optical waveguide plates, the plurality of optical waveguide plates are provided in an overlaid manner, each optical waveguide plate of the plurality of optical waveguide plates is provided with an in-coupling structure, a turning structure, an out-coupling structure and a diffraction inhibition layer,
the turning structure and the out-coupling structure on the same optical waveguide plate are located on two side surfaces of the optical waveguide plate respectively, projections of the turning structure and the out-coupling structure on the optical waveguide plate are at least partially overlapped, and the diffraction inhibition layer is located between the out-coupling structure and the optical waveguide plate; and the turning structure comprises a plurality of cellular elements, and the plurality of cellular elements are provided in a rectangular array.

2. The optical waveguide assembly according to claim 1, wherein there are at least two optical waveguide plates, and the in-coupling structure and the turning structure on the same optical waveguide plate are provided on the same side surface at a distance.

3. The optical waveguide assembly according to claim 1, wherein
there are one or more in-coupling structures on the same optical waveguide plate, and when there are a plurality of in-coupling structures, the plurality of in-coupling structures are provided at a distance.

4. The optical waveguide assembly according to claim 1, wherein projections of the plurality of in-coupling structures on adjacent optical waveguide plates of the plurality of optical waveguide plates are overlapped or staggered.

5. The optical waveguide assembly according to claim 1, further comprising an optical engine, wherein there are one or more optical engines, and the optical engine is configured to emit light to the in-coupling structure.

6. The optical waveguide assembly according to claim 5, wherein
when there is one optical engine, the optical engine is a multi-color optical engine, and when the multi-color optical engine emits light of at least three different wavebands, projections of the in-coupling structures on two adjacent optical waveguide plates of the plurality of optical waveguide plates on one of the optical waveguide plates are overlapped

7. The optical waveguide assembly according to claim 5, wherein
when there is a plurality of optical engines, the plurality of optical engines emit light of different wavebands, projections of the in-coupling structures on two adjacent optical waveguide plates of the plurality of optical waveguide plates on one of the optical waveguide plates are staggered, and the plurality of optical engines correspond one-to-one to the plurality of in-coupling structures on different optical waveguide plates.

8. The optical waveguide assembly according to claim 1, wherein the cellular elements are rectangular, each rectangular cellular element of the cellular elements is divided into a plurality of grids, the plurality of grids are sequentially arranged in at least two directions, each grid of the plurality of grids is provided with a grating, and the gratings of the plurality of grids of the same cellular element are the same or different.

9. The optical waveguide assembly according to claim 1, wherein a refractive index of the diffraction inhibition layer is smaller than a refractive index of the optical waveguide plate on which the diffraction inhibition layer is located.

10. The optical waveguide assembly according to claim 1, wherein the diffraction inhibition layer is connected to the optical waveguide plate by means of optical adhesive or deposited on the optical waveguide plate through a coating process.

11. The optical waveguide assembly according to claim 1, wherein
a projection of the out-coupling structure of the same optical waveguide plate falls within a projection range of the diffraction inhibition layer on the same optical waveguide plate.

12. The optical waveguide assembly according to claim 1, wherein
a projection of the diffraction inhibition layer of the same optical waveguide plate completely covers the optical waveguide plate.

13. The optical waveguide assembly according to claim 1, wherein there is one diffraction inhibition layer on the same optical waveguide plate.

14. The optical waveguide assembly according to claim 1, wherein the diffraction inhibition layer has a fixed refractive index or a refractive index that varies in a thickness direction of the diffraction inhibition layer.

15. The optical waveguide assembly according to claim 14, wherein
when the diffraction inhibition layer has a fixed refractive index, the diffraction inhibition layer has a refractive index greater than or equal to 1.65 and smaller than or equal to 2.65; and/or
when the diffraction inhibition layer has a refractive index that varies in the thickness direction of the diffraction inhibition layer, the diffraction inhibition layer has a refractive index greater than or equal to 1.7 and smaller than or equal to 2.0; and/or
when the diffraction inhibition layer has a refractive index that varies in the thickness direction of the diffraction inhibition layer, the diffraction inhibition layer has a refractive index that gradually decreases in a direction away from the optical waveguide plate on which the diffraction inhibition layer is located.

16. The optical waveguide assembly according to claim 1, wherein
the diffraction inhibition layer has a thickness greater than or equal to 100 nm and smaller than or equal to 1 mm; and/or the optical waveguide plate has a thickness greater than or equal to 400 μm and smaller than or equal to 1 mm; and/or
the optical waveguide plate has a refractive index greater than or equal to 1.65 and smaller than or equal to 2.65.

17. The optical waveguide assembly according to claim 1, wherein
the in-coupling structures are one-dimensional gratings, and there are one or more layers of in-coupling structures, each layer having a height greater than or equal to 50 nm and smaller than or equal to 1000 nm; and/or
the in-coupling structure has a duty cycle greater than or equal to 30% and smaller than or equal to 80%, and the in-coupling structure has a period greater than or equal to 300 nm and smaller than or equal to 600 nm.

18. The optical waveguide assembly according to claim 1, wherein
the turning structures are two-dimensional gratings, and there are one or more layers of turning structures, each layer having a height greater than or equal to 30 nm and smaller than or equal to 300 nm; and/or
the turning structure has a duty cycle greater than or equal to 20% and smaller than or equal to 80%, and the turning structure has a period greater than or equal to 150 nm and smaller than or equal to 600 nm.

19. The optical waveguide assembly according to claim 1, wherein
the out-coupling structures are one-dimensional gratings, and there are one or more layers of out-coupling structures, each layer having a height greater than or equal to 30 nm and smaller than or equal to 500 nm.

20. The optical waveguide assembly according to claim 1, wherein the out-coupling structure has a duty cycle greater than or equal to 20% and smaller than or equal to 80%, and the out-coupling structure has a period greater than or equal to 200 nm and smaller than or equal to 600 nm.
